(19) United States
(12) Patent Application Publication
(10) Pub. No.: US 2014/0035707 A1
(43) Pub. Date: Feb. 6, 2014

(54) System and Method for Magnetization

(71) Applicants: Larry W. Fullerton, New Hope, AL (US); Mark D. Roberts, Huntsville, AL (US); Robert Scott Evans, Austin, TX (US)

(72) Inventors: Larry W. Fullerton, New Hope, AL (US); Mark D. Roberts, Huntsville, AL (US); Robert Scott Evans, Austin, TX (US)

(73) Assignee: CORRELATED MAGNETICS RESEARCH, LLC., New Hope, AL (US)

(21) Appl. No.: 13/959,201

(22) Filed: Aug. 5, 2013

Related U.S. Application Data
(60) Provisional application No. 61/742,260, filed on Aug. 6, 2012.

(51) Int. Cl. H01F 13/00

(52) U.S. Cl. CPC H01F 13/00
USPC 335/284

(57) ABSTRACT

A system and a method are described herein for magnetizing magnetic sources into a magnetizable material. In one embodiment, the method comprises: (a) providing an inductor coil having multiple layers and a hole extending through the multiple layers; (b) positioning the inductor coil next to the magnetizable material; and (c) emitting from the inductor coil a magnetic field that magnetizes an area on a surface of the magnetizable material, wherein the area on the surface of the magnetizable material that is magnetized is in a direction other than perpendicular to the magnetizable material such that there is a magnetic dipole with both a north polarity and a south polarity formed on the surface of the magnetizable material.

### CLAIM OF PRIORITY

This application claims the benefit U.S. Provisional Application Ser. No. 61/742,260 filed on Aug. 6, 2012. The contents of this document are incorporated by reference herein.

### TECHNICAL FIELD

The present invention relates generally to a system and method for magnetization. More particularly, the present invention relates to a system and method for magnetizing magnetic sources into a magnetizable material.

### BACKGROUND

A wide metal inductor coil for magnetizing magnetic sources known as maxels into a magnetizable material is described in U.S. Pat. No. 8,179,219, issued May 15, 2012, the contents of which are incorporated by reference herein. This known wide metal inductive coil 114 is shown in FIGS. 1A-1B (PRIOR ART). The wide metal inductive coil 114 includes a first circular conductor 116a having a desired thickness and a hole 118a through it and a slotted opening 120a extending from the hole 118a and across the first circular conductor 116a to produce a discontinuity in the first circular conductor 116a. The wide metal inductive coil 114 further includes a second circular conductor 116b having a hole 118b and a slotted opening 120b extending from the hole 118b and across the circular conductor 116b to produce a discontinuity in the second circular conductor 116b. The first and second circular conductors 116a and 116b are designed such that they can be soldered together at a solder joint 122 that is beneath the first circular conductor 116a and on top of the second circular conductor 116b. Other attachment techniques other than soldering can also be used. Prior to the first and second circular conductors 116a and 116b being soldered together, insulation layers 124a and 124b are respectively placed beneath each of the circular conductors 116a and 116b. The insulation layer 124a is placed beneath the first circular conductor 116a so it does not cover the solder region 122 but otherwise insulates the remaining portion of the bottom of the first circular conductor 116a from the second circular conductor 116b. When the first and second circular conductors 116a and 116b are soldered together the insulation layer 124a between them prevents current from conducting between them except at the solder joint 122. The second insulation layer 116b beneath the second circular conductor 116b prevents current from conducting to the magnetizable material 130 (see FIG. 1B (PRIOR ART)). So, if the magnetizable material 130 is non-metallic, for example, a ceramic material, then the second insulation layer 116b is not needed. Moreover, if the magnetizable material 130 has generally insignificant conductive properties then the second insulation layer 116b is optional.

A first wire conductor 126 is soldered to the top of the first circular conductor 116a at a location next to the slotted opening 120a but opposite the solder joint 122. The second circular conductor 116b has a grove (or notch) 127 in the bottom of it which can receive a second wire conductor 128 that is then soldered to the second circular conductor 116b such that the bottom of the second circular conductor 116b remains substantially flat. Other methods can also be employed to connect the second wire conductor 128 to the second circular conductor 116b including placing the second wire conductor 128 into a hole drilled through a side of the second circular conductor 116b and then soldering the second wire conductor 116 to the second circular conductor 116b. As depicted in FIG. 1A (PRIOR ART), the second wire conductor 128 is fed through the holes 118a and 118b in the first and second circular conductors 116a and 116b and then through the groove (or notch) 127. Thus, when the two wire conductors 126 and 128 and the first and second circular conductors 116a and 116b are soldered together with the insulation layer 124a in between the two circular conductors 116a and 116b they form two turns of a coil. In this set-up, the current from the first conductor 126 can enter the first circular conductor 116a, travel clockwise around the first circular conductor 116a, travel through the solder joint 122 to the second circular conductor 116b, travel clockwise around the second circular conductor 116b and then out the second wire conductor 128, or current can travel the opposite path. Hence, depending on the connectivity of the first and second wire conductors 126 and 128 to the wide metal inductor coil 114 (magnetizing circuit 114) and the direction of the current received from the wide metal inductor coil 114 (magnetizer circuit), a South polarity magnetic field source or a North polarity magnetic field source are produced in the magnetizing material 130 (see FIG. 1B).

FIG. 1B (PRIOR ART) depicts a side view of a cross section of the wide metal inductor coil 114. A characterization of the magnetic field 119 (dashed lines) produced by the wide metal inductor coil 114 during magnetization illustrates that the wide metal inductor coil 114 produces a strong magnetic field 119 in the holes 118a and 118b, where the magnetizing field 119 is provided perpendicular (see dashed arrow) to the magnetizable material 130 being magnetized such that a North up or South up polarity magnetic source is printed into the magnetizing material 130. In other words, the magnetic dipole (magnetic source, maxel) has either a North or South polarity on the surface of the magnetizing material 130 and an opposite pole beneath the surface of the magnetizing material 130. Various improved wide metal inductor coils are described in U.S. Non-provisional patent application Ser. No. 12/895,589, filed Sep. 30, 2010, titled “System and Method for Energy Generation”, and U.S. patent Non-provisional application Ser. No. 13/240,355, filed Sep. 22, 2011, titled “Magnetic Structure Production”, the contents of which are incorporated herein by reference.

Referring to FIGS. 2A-2E (PRIOR ART), there are illustrated different aspects of an exemplary magnetic print head 141 (similar to wide metal inductor coil 114) for a maxel-printing magnetic printer. It should be understood that more or fewer parts than those described and/or illustrated may alternatively comprise the magnetic print head 141. Similarly, parts may be modified and/or combined in alternative manners that differ from those that are described and/or illustrated. For certain example embodiments, FIG. 2B (PRIOR ART) depicts an example outer layer 132 of the magnetic print head 141. The outer layer 132 may comprise a thin metal (e.g., 0.01″ thick copper) having a generally round or circular shape (e.g., with a 16 mm diameter) and having substantially one-fourth of the circular shape removed or otherwise not present. The outer layer 132 may include a tab 134 for receiving an electrical connection. The outer layer 132 may define or include at least part of a hole portion 135a that, when combined with one or more other layers 136 which has at least part of a hole portion 135b, results in a hole 121 (e.g., with a 1 mm diameter) being formed in an approximate center of the magnetic print head 141. As shown for an example implementation, the outer layer 132 may be formed at least partially from a substantially flat plate. An arrow is illustrated on the outer layer 132 to indicate that a current received from the tab 134 may traverse around a three-quarter moon portion of the outer layer 132. It should be noted that sizes, material types, shapes, etc. of component parts are provided by way of example but not limitation; other sizes, material types, shapes, etc. may alternatively be utilized and/or implemented.

For example implementations, a diameter of one or more of the layers 132 and 136 of the magnetic print head 141, which can also have a shape other than round (e.g., oval, rectangular, elliptical, triangular, hexagonal, etc.), may be selected to be large enough to handle a load of a current passing through the print head layers 132 and 136 and also large enough to substantially ensure no appreciable reverse magnetic field is produced near the hole 121 where the magnetic print head 141 produces a maxel (magnetic source) in the magnetizing material 130. Although the hole 121 is also shown to comprise a substantially circular or round shape, this is by way of example only, and it should be appreciated that the hole 121 may alternatively comprise other shapes including but not limited to, oval, rectangular, elliptical, triangular, hexagonal, and so forth. Moreover, a size of the hole 121 may correspond to a desired maxel resolution in the magnetizing material 130, whereby a given print head 141 may have a different sized hole 121 so as to print different sized maxels in the magnetizing material 130. Example diameter sizes of holes 121 in print heads 141 may include, but are not limited to, 0.7 mm to 4 mm. In addition, the diameter sizes of holes 121 may alternatively be smaller or larger, depending on design and/or particular application.

FIG. 2C (PRIOR ART) depicts an example inner layer 136 of the magnetic print head 141. The inner layer 136 may be similar to the outer layer 132, except that it does not include a tab (e.g., see outer layer's tab 134 in FIG. 2B (PRIOR ART)). As shown for an example implementation, current (see arrow) may traverse around the three-quarter moon portion of the inner layer 136.

FIG. 2D (PRIOR ART) depicts an example non-conductive spacer 138 for the magnetic print head 141. The spacer 138 may be designed (e.g., in terms of size, shape, thickness, a combination thereof, etc.) to fill a portion of the outer layer 132 and/or the inner layer 136 such that the layers 132 and 136 have a conductive and a non-conductive portion. In an example implementation, the outer and inner layers 132 and 136 may still provide complete circular structures such that if they are stacked, they have no air regions other than the central hole 121. The central hole 121 may also be filled with a magnetizable material. Although shown as occupying one-quarter of a circle, the spacer 138 may alternatively by shaped differently. If the spacer 138 is included in the design of the print head 141, then the assembled print head 141 would be more rigid and therefore more robust and/or stable to thereby increase its lifecycle.

FIG. 2E (PRIOR ART) depicts an example weld joint 140 between the outer layer 132 and the inner layer 136 with two spacers 138a and 138b. As shown for an example implementation, the outer and inner layers 132 and 136 may have portions 139a and 139b that overlap to form the weld joint 140. The weld joint 140 may comprise an area that is used for attaching two layers 132 and 136 via some attachment mechanism including, but not limited to, welding (e.g., heliarc welding), soldering, adhesive, any combination thereof, and so forth.

For an example assembly procedure, prior to attaching the two layers 132 and 136 that are electrically conductive, an insulating material (e.g., Kapton) may be placed on top of the outer layer 132 (and/or beneath the inner layer 136) so as to insulate one layer from the other. After welding, the insulating material may be cut away or otherwise removed from the weld joint 140, which enables the two conductor portions to be electrically attached thereby producing one and one-half turns of an inductor coil. Alternatively, an insulating material may be placed against a given layer 132 or 136 such that it insulates the given layer 132 or 136 from an adjoining layer except for a portion corresponding to the weld joint 140 between the two adjoining layers 132 and 136. During an example operation, an insulating material may prevent current from passing between the layers 132 and 136 except at the weld joint 140 thereby resulting in each adjoining layer acting as three-quarters of a turn of an inductor coil (e.g., of the print head 141) if using example layer designs as illustrated in FIGS. 2B-2C (PRIOR ART).

Although the aforementioned wide metal inductive coil 114 and the magnetic print head 141 work well it is still desirable to improve upon these components or at least how these components can be used in a different manner to form magnetizing magnetic sources (maxels) into a magnetizable material. Such improvements are the subject of the present invention.

### SUMMARY

A system and method for magnetizing magnetic sources into a magnetizable material are described in the independent claims of the present application. Advantageous embodiments of the system and method have been described in the dependent claims of the present application.

In one aspect, the present invention provides a system for magnetizing magnetic sources into a magnetizable material. In one embodiment, the system comprises: (a) an inductor coil which has multiple layers forming a coil and a hole extending through the multiple layers; (b) a positioning device configured to position the inductor coil next to the magnetizable material; and (c) an electrical power source configured to provide electricity to the inductor coil such that the inductor coil emits a magnetic field that magnetizes an area on a surface of the magnetizable material, wherein the area on the surface of the magnetizable material is magnetized in a direction other than perpendicular to the magnetizable material such that there is a magnetic dipole with both a north polarity and a south polarity formed on the surface of the magnetizable material. In addition, the system may comprise multiple inductor coils which can magnetize multiple magnetic dipoles each with a north polarity and a south polarity on the surface of the magnetizable material.

In another aspect, the present invention provides a method for magnetizing magnetic sources into a magnetizable material. The method comprises steps of: (a) providing an inductor coil having multiple layers forming a coil and a hole extending through the multiple layers; (b) positioning the inductor coil next to the magnetizable material; and (c) emitting from the inductor coil a magnetic field that magnetizes an area on a surface of the magnetizable material, wherein the area on the surface of the magnetizable material is magnetized in a direction other than perpendicular to the magnetizable material such that there is a magnetic dipole with both a north polarity and a south polarity formed on the surface of the magnetizable material. In addition, the method may utilize multiple inductor coils to magnetize multiple magnetic dipoles each with a north polarity and a south polarity on the surface of the magnetizable material.

Additional aspects of the invention will be set forth, in part, in the detailed description, figures and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

A more complete understanding of the present invention may be obtained by reference to the following detailed description when taken in conjunction with the accompanying drawings wherein:

FIGS. 1A-1B (PRIOR ART) illustrate a wide metal inductive coil which is positioned next to a magnetizing material such that when the wide metal inductive coil produces a magnetic field it is provided perpendicular to the magnetizable material being magnetized such that a North up or South up polarity magnetic source is printed in the the magnetizing material;

FIGS. 2A-2E (PRIOR ART) illustrate different aspects of an exemplary magnetic print head (similar to the wide metal inductive coil of FIGS. 1A-1B) for a maxel-printing magnetic printer;

FIGS. 3A-3D are several drawings of a wide metal inductor coil that is positioned relative to a magnetizable material so as to produce a magnetic field that magnetizes the magnetizable material in a direction parallel to the magnetizable material rather than perpendicular to the magnetizable material in accordance with an embodiment of the present invention;

FIGS. 4A-4C show different layers which are attached via butt welds to form the wide metal inductor coil shown in FIGS. 3A-3D in accordance with an embodiment of the present invention;

FIGS. 5A-5I are several drawings of exemplary wide metal inductor coils which have all sorts of shapes and sizes themselves and holes with all sorts of shapes and sizes in accordance with different embodiments of the present invention;

FIGS. 6A-6G are various diagrams illustrating how the wide metal inductor coils shown in FIGS. 2-5 or any wide metal inductor coil for that matter can be protected by placing it in a casting compound in accordance with an embodiment of the present invention;

FIGS. 7A-7D are several drawings of exemplary magnetic structures (maxels) that can be formed on the magnetizable material in accordance with different embodiments of the the present invention;

FIGS. 8A-8L are various side-view diagrams which illustrate how a print head (wide metal inductor coil) can be tilted relative to the surface of the magnetizable material such that the magnetic field on the print head's outer perimeter magnetizes (prints) a magnetic source (maxel) on the magnetizable material in a direction other than perpendicular and other than parallel to the magnetizable material in accordance with different embodiments of the present invention; and

FIGS. 9A-9F are several diagrams illustrating a print head (wide metal inductor coil) which has angled hole formed therein in accordance with an embodiment of the present invention.

### DETAILED DESCRIPTION

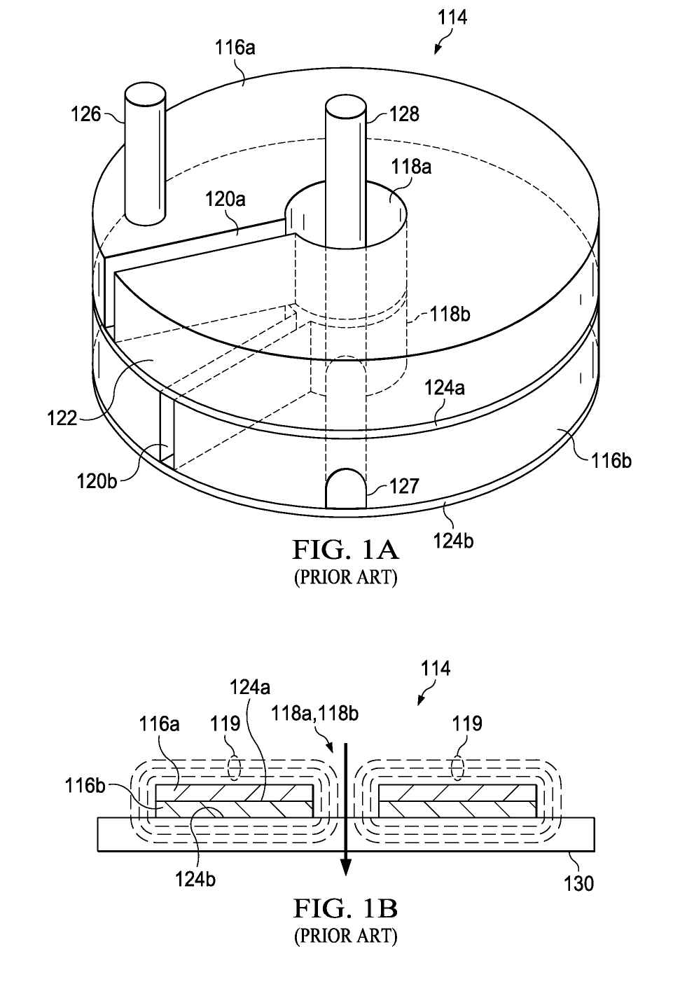

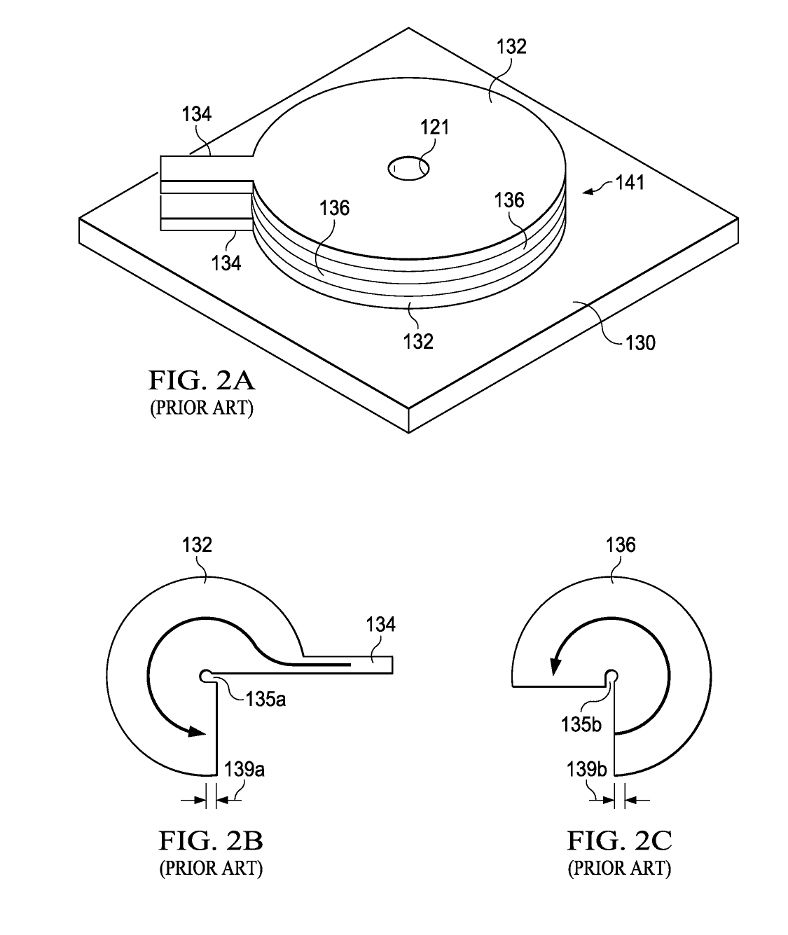

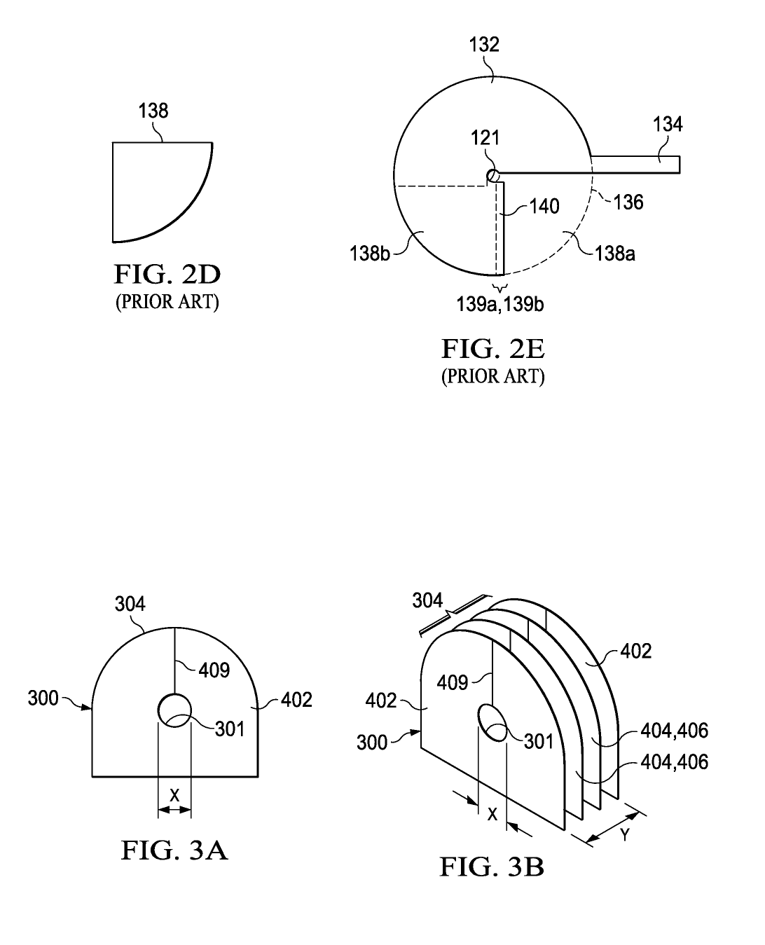

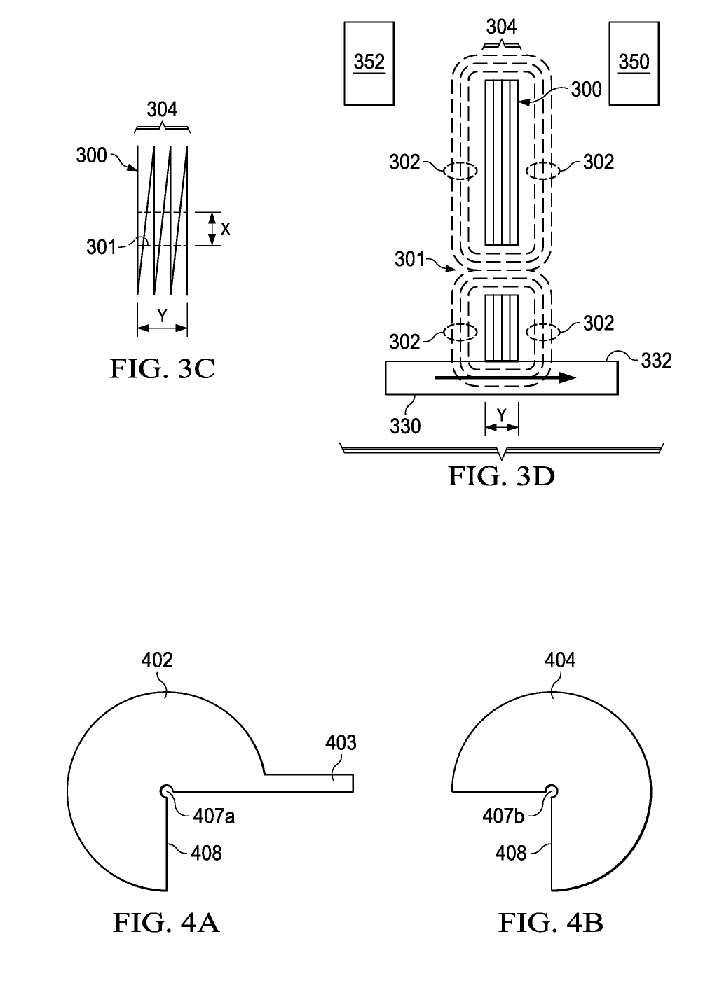

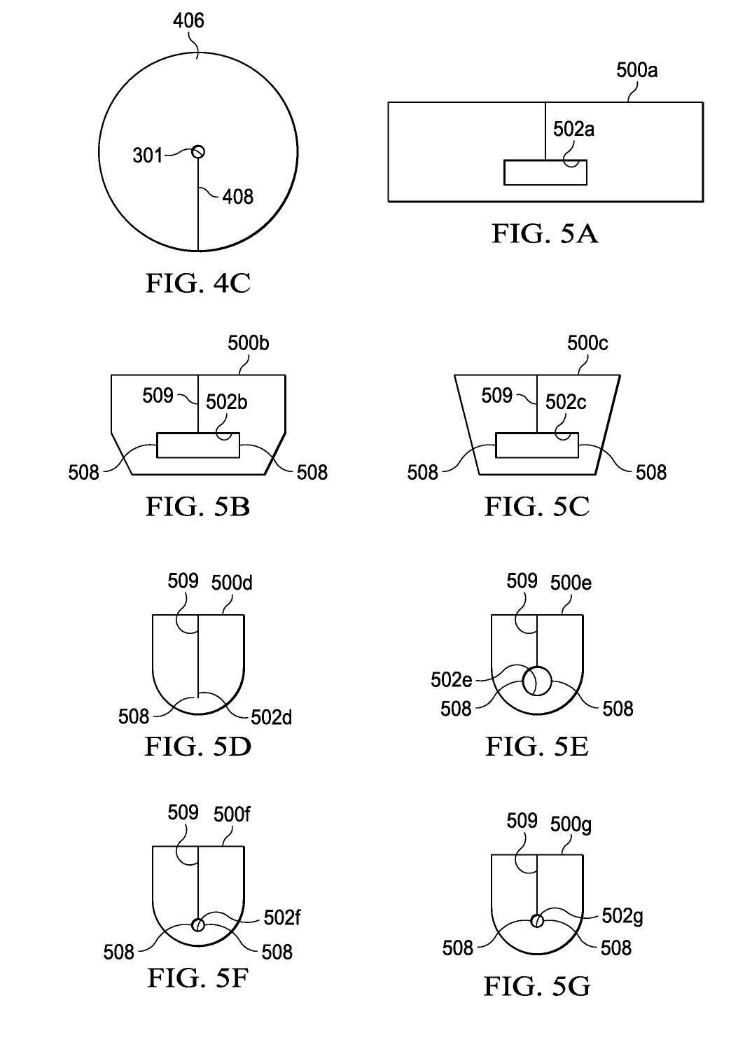

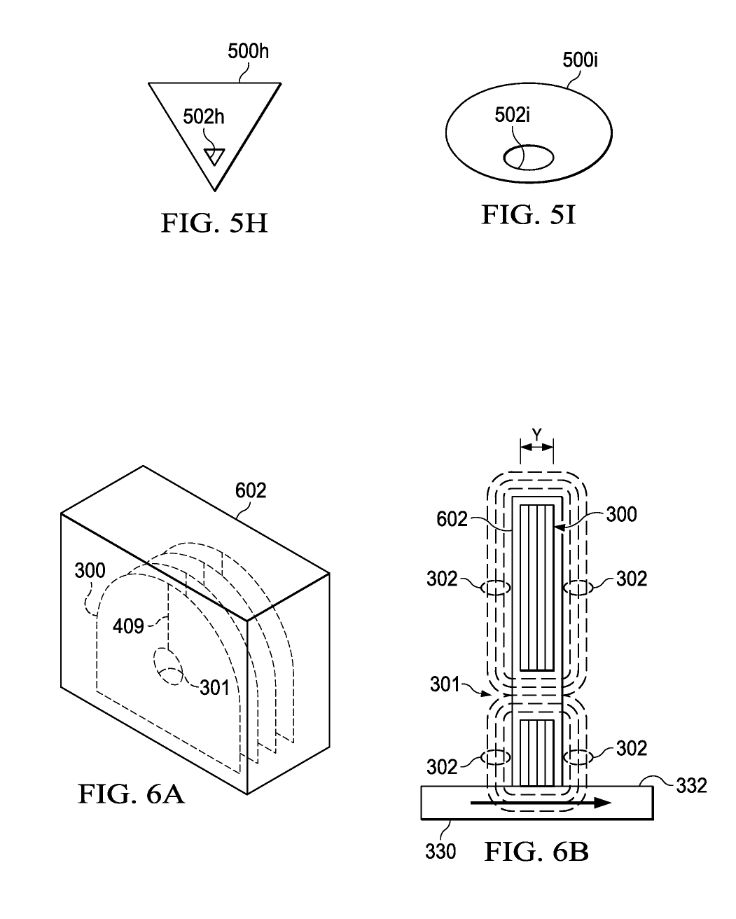

Referring to FIGS. 3A-3D, there are several drawings of a wide metal inductor coil 300 that is positioned relative to a magnetizable material 330 so as to produce a magnetic field 302 (dashed lines) that magnetizes in a direction parallel (dashed arrow) to the magnetizable material 330 rather than perpendicular to the magnetizable material 330. As discussed above, the wide metal inductor coil 114 and 141 shown in FIGS. 1-2 (PRIOR ART) are positioned so as to use the magnetic field near their hole 118 and 121 to magnetize the magnetizable material 130 in a direction that is perpendicular to the magnetizable material 130 which means there is a north up or south up polarity magnetic source printed into the surface of the magnetizing material 130. In contrast, the wide metal inductor coil 300 is positioned relative to the magnetizable material 330 such that the magnetic field 302 produced at the outer perimeter 304 rather than the magnetic field 302 produced at the hole 301 of the wide metal inductor coil 300 is used magnetize the magnetizable material 330. In the illustrated example, the wide metal inductor coil 300 is positioned such that the direction of magnetization (dashed arrow) is parallel to a surface 332 of the magnetizable material 330 which means there is a north polarity and a south polarity formed on the surface 332 of the magnetizable material 330 (see FIG. 3D's side view). The wide metal inductor coil 300 has a configuration such that the width X of the hole 301 and the height Y of the wide metal inductor coil 300, which is a function of thickness of each layer and the number of turns, determine the area on the surface 332 of a magnetizable material 330 that is subjected to the magnetic field 302 (see FIG. 3A's side view and FIG. 3C's top view). One skilled in the art with the teachings herein will readily appreciate that there is a wide variety of metal inductor coils 114, 141, 300 etc. . . . that can be positioned relative to the magnetizable material 330 (or vice versa) so as to form (print) a north polarity and a south polarity on the surface 332 of the magnetizable material 330 in accordance with the present invention. Some exemplary wide metal inductor coils 300, 500a, 500b . . . 500n in accordance with different embodiments of the present invention are described in detail next with respect to FIGS. 4A-4C and 5A-5I.

Referring to FIGS. 4A-4C, there are shown different layers 402, 404, and 406 which are attached via butt welds (where the different layers are butt-up against each other and welded together, using a laser welder) to form the aforementioned wide metal inductor coil 300. FIGS. 4A-4B respectively depict an outer layer 402 having a tab 403 and an inner layer 404. Each of the two layers 402 and 404 have an edge 408 that can be butted against another and welded to form a butt weld edge 409. Further, each of the two layers 402 and 404 define or include at least part of a hole portion 407a and 407b such that their being combined results in the formation of the hole 301 (e.g., with a 1 mm diameter) in an approximate center of the wide metal inductor coil 300 (magnetic print head 300)(see FIGS. 3A-3D). Further, the two layers 402 and 404 are similar to layers 132 and 136 in the magnetic print head 141 of FIGS. 2A-2E (PRIOR ART) except the two layers 402 and 404 do not include the overlap portions 139a and 139b in layers 132 and 136 which are used to provide the weld joint 140. FIG. 4C depicts the middle layer 406 which is a full circle with a slit that provides two edges 408, where a left edge of one layer can butt against the right edge of a layer above or beneath the layer (or vice versa). Plus, the middle layer 406 has a hole 301 formed therein.

Referring to FIGS. 5A-5I, there are shown side-views of exemplary wide metal inductor coils 500a, 500b, 500c, 500d, 500e, 500f, 500g, 500h, and 500i which have all sorts of sizes and shapes in accordance with different embodiments of the present invention. Further, the wide metal inductor coils 500a, 500b, 500c, 500d, 500e, 500f, 500g, 500h, and 500i have different shapes and sizes of holes 502a, 502b, 502c, 502d, 502e, 502f, 502g, 502h, and 502i . These holes 502a, 502b, 502c, 502d, 502e, 502f, 502g, 502h, and 502i may be just non-welded portions of abutted edges 508 which when welded to one another form weld 509. For instance, the size of the resulting hole 502d can be as small as the cut in the metal layer that produces the two butt edges 508 (see FIG. 5D). One skilled in the art with these teachings will recognize that all sorts of print head designs based on wide metal inductor coils 500a, 500b, 500c, 500d, 500e, 500f, 500g, 500h, and 500i are possible which can be used/positioned to produce a magnetic field that magnetizes the surface 332 of the magnetizable material 330 in a direction that is parallel rather than perpendicular with respect to the magnetizable material 330 which means there is a north polarity and a south polarity formed on the surface 332 of the magnetizable material 330.

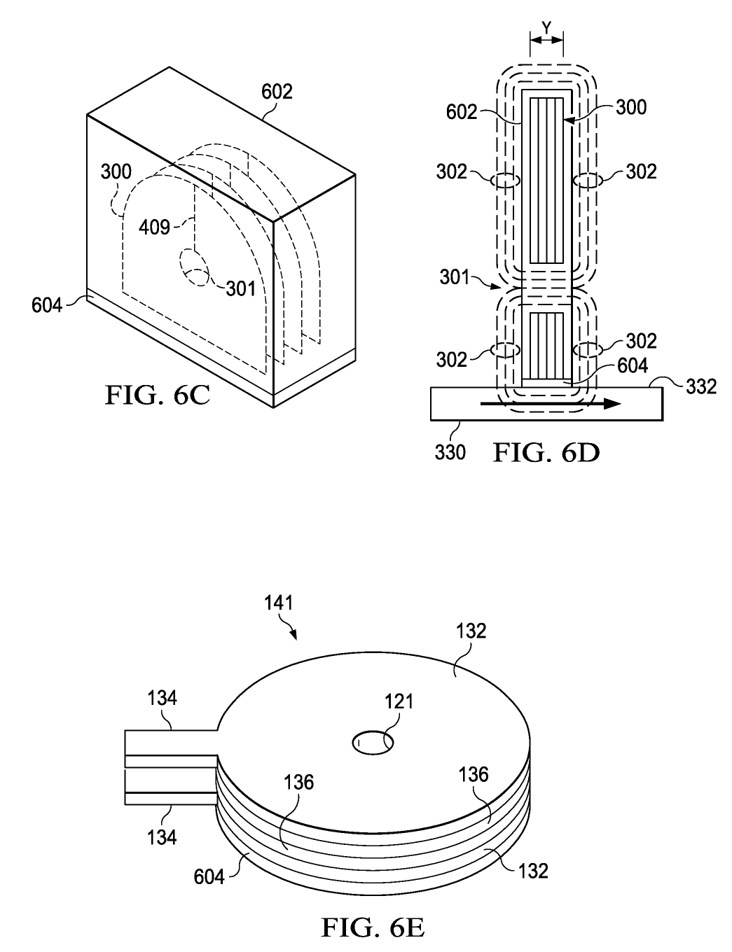

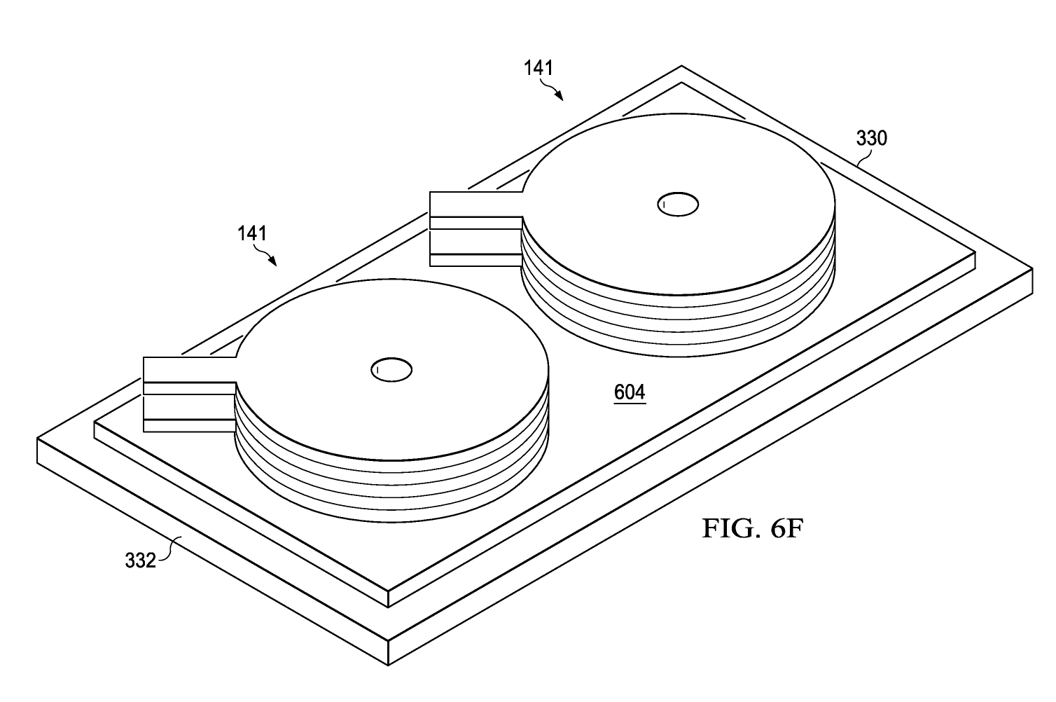

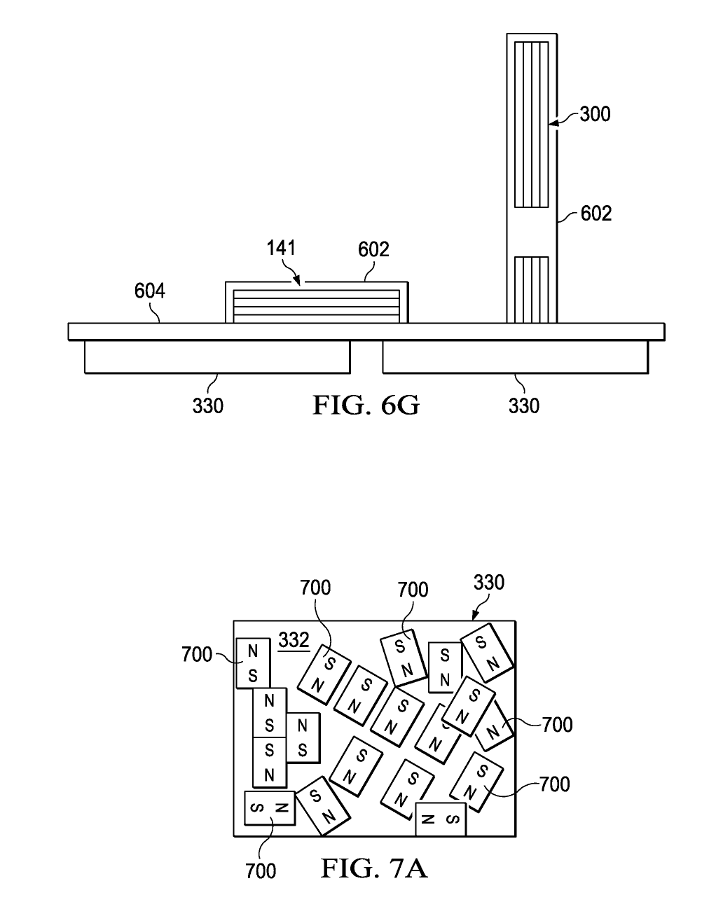

Referring to FIGS. 6A-6G, there are shown various diagrams illustrating how the aforementioned wide metal inductor coils 114, 141, 300 (shown), 500a, 500b, 500c, 500d, 500e, 500f, 500g, 500h, and 500i or any wide metal inductor coil for that matter can be protected by placing it in a casting compound 602 (e.g., acrylic casting compound 602) in accordance with an embodiment of the present invention. The casting compound 602 will harden and prevent damage to wide metal inductor coil 300, which is typically made up of thin relatively soft metal layers of copper. FIG. 6B shows a side-view of the wide metal inductor coil 300 (for example) encapsulated with the casting compound 602 and placed next to the magnetizable material 330 so as to produce the magnetic field 302 that magnetizes the surface 332 of the magnetizable material 330 in a direction that is parallel (see dashed arrow) rather than perpendicular which means there is a north polarity and a south polarity formed on the surface 332 of the magnetizable material 330. In FIGS. 6C-6D, the wide metal inductor coil 300 (for example) is shown which is not only encapsulated with the casting compound 602 but also has a protective layer 604 attached thereto. The protective layer 604 could be a thin metal layer such as a 0.003″ thick layer of titanium or chrome. The protective layer 604 can be used in addition to the casting compound 602 (as shown) or as an alternative to the casting compound 602 depending on the application. For example, the protective layer 604 can be placed at the bottom of an individual inductor coil such as the wide metal inductor coil 141 without using the casting compound 602 (see FIG. 6E). Alternatively, the protective layer 604 can be between multiple inductor coils 141 and the magnetizable material 330 (see FIG. 6F). Or, the protective layer 604 can be between inductor coils 141 and 300 and the magnetizable material 330 (see FIG. 6G) where in this example the two inductor coils 141 and 300 are also protected by the casting compound 602. If desired, an insulating layer (e.g., insulating layer 124b) can be placed between an inductor coil, such as inductor coil 300, and the protective layer 604 as necessary to prevent current from conducting between the inductor coil 300 (for example) and the protective layer 604. Generally, one skilled in the art will recognize with the teachings herein that casting compounds 602 and/or protective layers 604 can be used to enable the print head (e.g., wide metal inductor coil 114, 141, 300 (shown), 500a, 500b, 500c, 500d, 500e, 500f, 500g, 500h, and 500i) to be moved across the magnetizable material 330 from one maxel location to another without lifting the print head or magnetizable material 330 (or vice versa) so as to avoid damage to the print head during such movement.

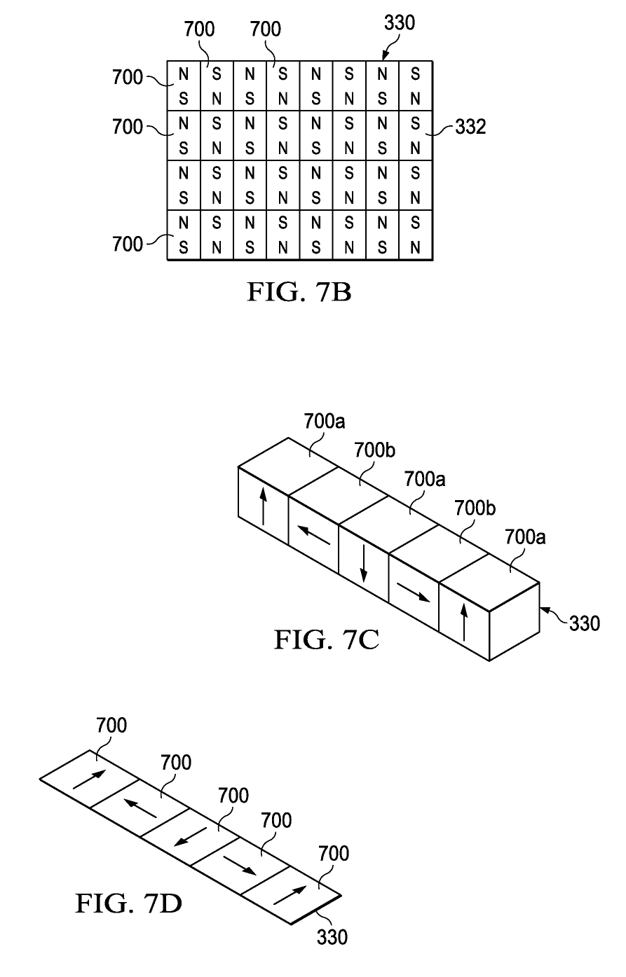

Referring to FIGS. 7A-7D, there are illustrated several drawings of exemplary magnetic structures 700 (maxels 700) that can be formed on the magnetizable material 330 in accordance with the present invention. FIG. 7A depicts multiple magnetic sources 700 (19 shown) printed parallel to the surface 332 of the magnetizable material 330 in somewhat of a random pattern, where each magnetic source 700 has a south polarity portion and a north polarity portion. It should be appreciated that the print head (e.g., wide metal inductor coil 300) and or the magnetizable material 330 can be rotated to establish the print direction of each magnetic source 700. FIG. 7B depicts rows and columns of printed magnetic sources 700 that resemble a checkerboard pattern on the surface 332 of the magnetizable material 330. FIG. 7C depicts magnetic sources 700a and 700b in a Halbach array pattern printed into an axially sintered magnetizable material 330 where a “vertical” print head 141 (for example) can be used to produce the South Up or North up polarity magnetic sources 700a and a “horizontal” print head 300 (for example) can be used to produce the South-North and North South magnetic sources 700b. FIG. 7D depicts a Halbach array pattern of magnetic sources 700 printed into a diametrically sintered magnetizable material 330 using a “horizontal” print head 300 (for example) where the direction of printing is a function of rotating the magnetizable material 330 or the “horizontal” print head 300. It should be noted that due to the magnetization direction on the magnetizable material 330, the field strength used to print magnetic sources 700 which are printed “with the grain” can be less than the field strength used to print magnetic sources 700 “against the grain” so as to compensate for magnetization limitations.

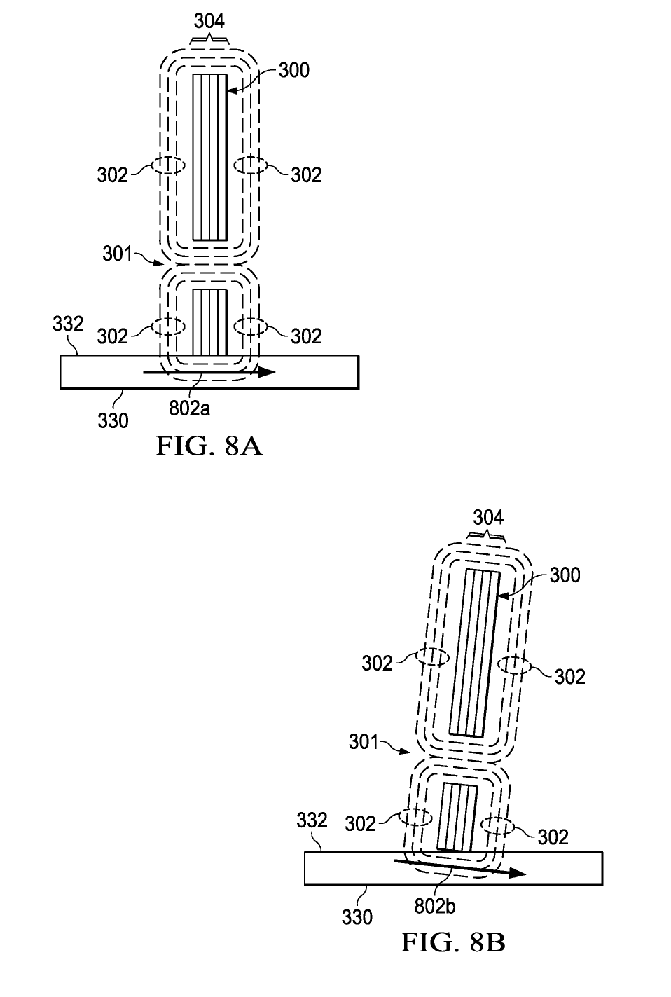

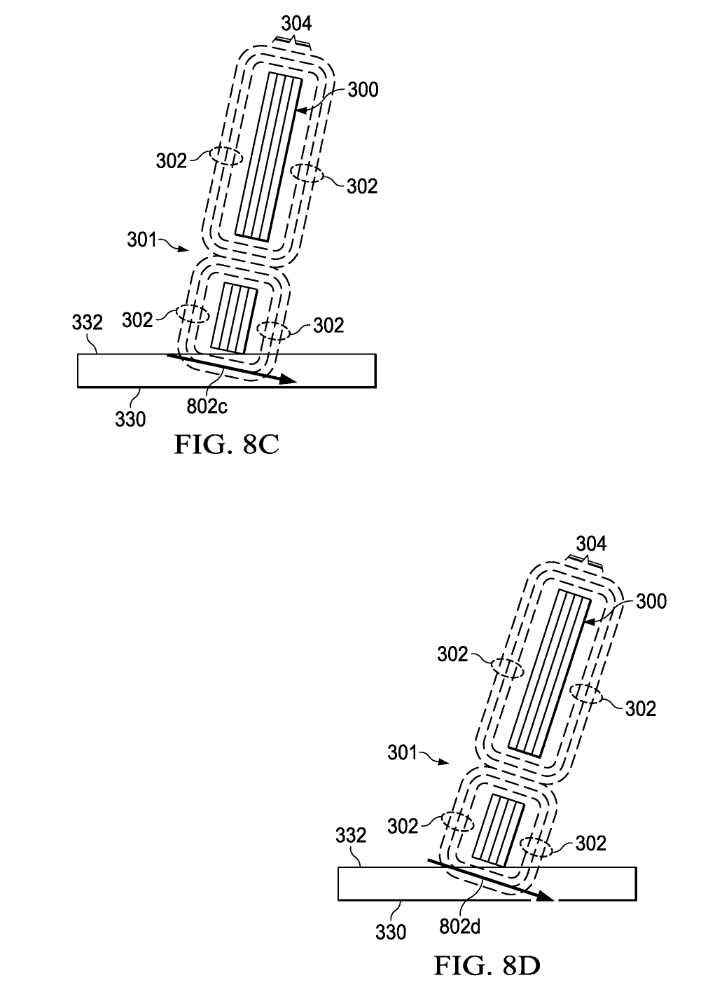

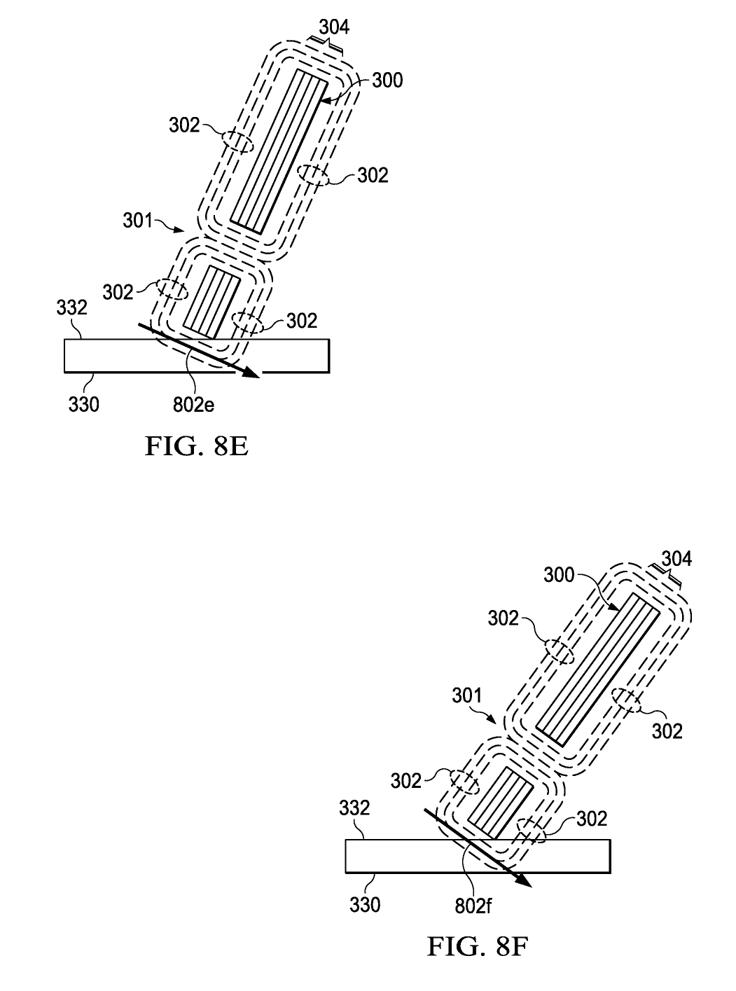

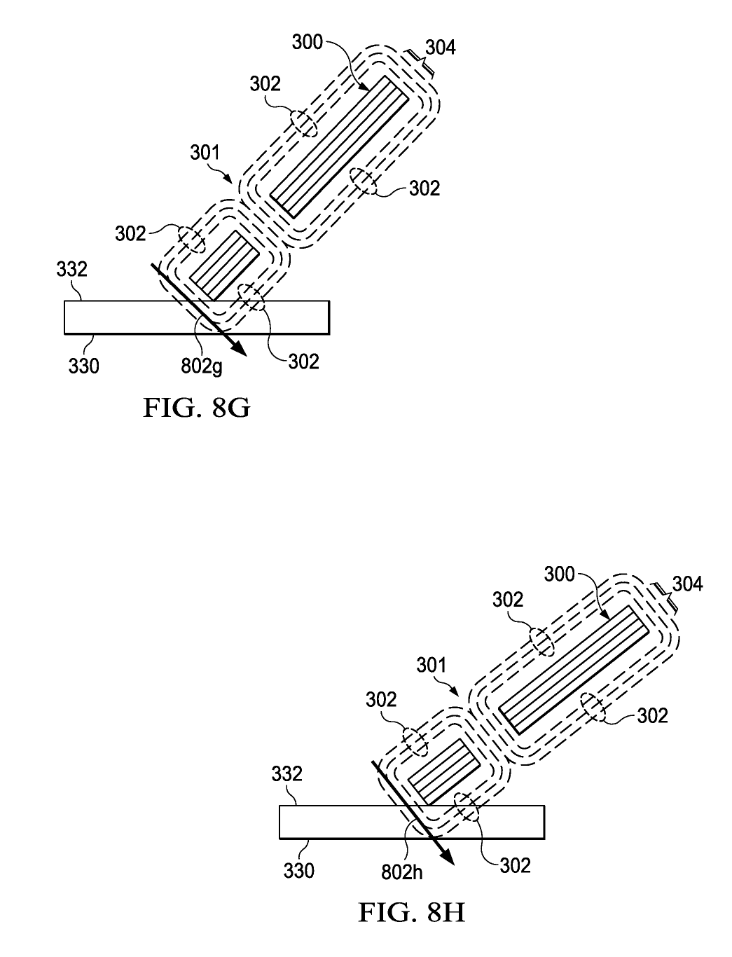

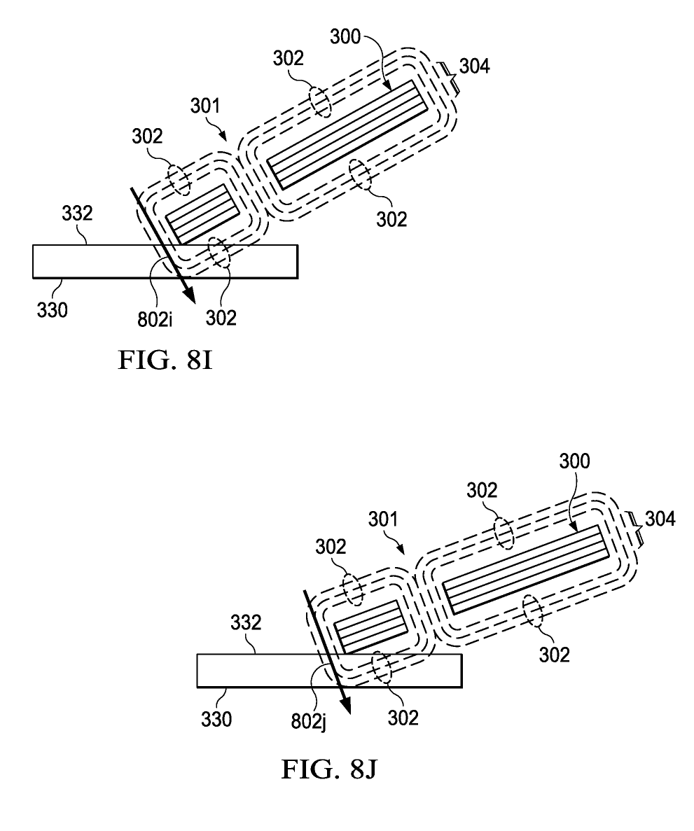

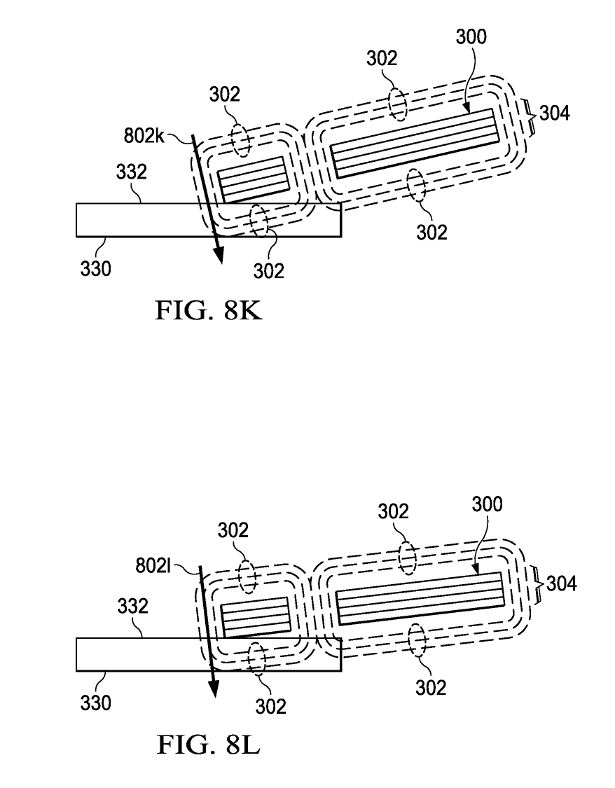

Referring to FIGS. 8A-8J, there are various side-view diagrams which illustrate how a print head 300 (for example) can be tilted relative to the surface 332 of the magnetizable material 330 such that the magnetic field 302 on the print head's outer perimeter 304 magnetizes (prints) a magnetic source (maxel) on the magnetizable material 330 in a direction (see arrows) other than perpendicular and other than parallel to the magnetizable material 330. In this example, FIGS. 8A-8L show several exemplary tilted print head 300 (tilted wide metal inductor coil 300) configurations to illustrate how different magnetization directions 802a, 802b, 802c, 802d, 802e, 802f, 820g, 802h, 802i, and 802l (dashed arrows) can be produced in the magnetizable material 330.

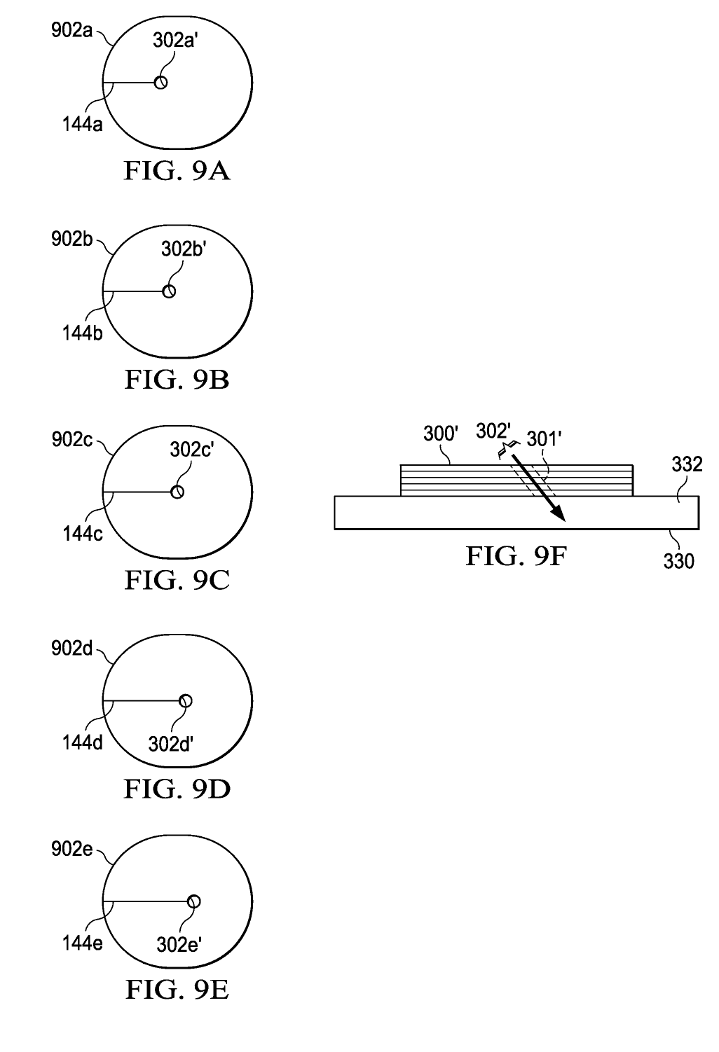

Referring to FIGS. 9A-9F, there are several diagrams illustrating a print head 300′ (wide metal inductor coil 300′) which has angled hole 302′ formed therein in accordance with an embodiment of the present invention. In particular, the print head 300′ has a hole 302′ that is slanted through the coil such that it can magnetize the magnetizable material 330 in a direction other than perpendicular or parallel to the surface 332 of the material 330. In this example, the wide metal inductor coil 300′ is made from multiple layers 902a, 902b, 902c, 902d and 902e each having holes 302a′, 302b′, 302c′, 302d′ and 302e′ at five different positions (from left to right) such that when the layers 902a, 902b, 902c, 902d and 902e are assembled they collectively form the angled hole 302′ in the wide metal inductor coil 300′. FIGS. 9A-9E respectively show top views of layers 902a, 902b, 902c, 902d and 902e with their respective holes 302a′, 302b′, 302c′, 302d′ and 302e′ which are offset from one another such that when they are assembled they form the wide metal inductor coil 300′ with the angled hole 302′. FIG. 9F is a side view of the wide metal inductor coil 300′ positioned next to the magnetizing material 330 so as to magnetize the magnetizable material 330 in a direction (see arrow) other than perpendicular or parallel to the surface 332 of the material 330.

In view of the foregoing, one skilled in the art will readily appreciate that the present invention includes a system and a method for magnetizing magnetic sources into a magnetizable material. For instance, the system could include an inductor coil 300 (for example)(actually multiple inductor coils could be used), a positioning device 350, and an electrical power source 352 (see FIG. 3D). The inductor coil 300 which has multiple layers 402, 404 and 406 forming a coil and a hole 301 extending through the multiple layers 402, 404 and 406. The positioning device 350 is configured to position the inductor coil 300 next to the magnetizable material 330 (or vice-versa). The electrical power source 352 is configured to provide electricity to the inductor coil 300 such that the inductor coil 300 emits a magnetic field 302 that magnetizes an area on a surface 332 of the magnetizable material 330, wherein the area on the surface 332 of the magnetizable material 330 is magnetized in a direction other than perpendicular to the magnetizable material 330 such that a magnetic dipole with both a north polarity and a south polarity is formed on the surface 332 of the magnetizable material 330.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims. It should also be noted that the reference to the “present invention” or “invention” used herein relates to exemplary embodiments and not necessarily to every embodiment that is encompassed by the appended claims.

1. A system for magnetizing magnetic sources into a magnetizable material, the system comprising:
an inductor coil having multiple layers forming a coil and a hole extending through the multiple layers;
a positioning device that positions the inductor coil next to the magnetizable material; and
an electrical power source that provides electricity to the inductor coil such that the inductor coil emits a magnetic field that magnetizes an area on a surface of the magnetizable material, wherein the area on the surface of the magnetizable material is magnetized in a direction other than perpendicular to the magnetizable material such that there is a magnetic dipole with both a north polarity and a south polarity formed on the surface of the magnetizable material.

2. The system of claim 1, wherein the positioning device is further configured to tilt the inductor coil with respect to the magnetizable material such that the inductor coil emits the magnetic field to magnetize the area of the surface of the magnetizable material in a direction other than perpendicular to the magnetizable material and other than parallel to the magnetizable material.

3. The system of claim 1, further comprising a protective layer which is placed between the inductor coil and the magnetizable material.

4. The system of claim 1, wherein the multiple layers are welded to one another to form the coil with a number of turns.

5. The system of claim 4, wherein the weld is an overlap weld or a butt weld.

6. The system of claim 1, wherein a height of the coil which is a function of a thickness of each layer and the number of turns along with a width of the hole determines the area on the surface of the magnetizable material that is magnetized by the inductor coil.

7. The system of claim 1, wherein the inductor coil is placed in a casting compound.

8. The system of claim 1, wherein the hole formed in the inductor coil is a slanted hole.

9. The system of claim 1, wherein the hole formed in the inductor coil is either a rectangular-shaped hole, a circular-shaped hole, a triangular-shaped hole, or an oval-shaped hole.

10. The system of claim 1, further comprising:
another inductor coil having multiple layers forming a coil and a hole extending through the multiple layers;
the positioning device also positions the another inductor coil next to the magnetizable material; and
the electrical power source also provides electricity to the another inductor coil such that the another inductor coil emits a magnetic field that magnetizes another area on the surface of the magnetizable material, wherein the another area on the surface of the magnetizable material is magnetized in a perpendicular direction such that there is a magnetic dipole with either a north polarity or a south polarity formed on the surface of the magnetizable material.

11. A method for magnetizing magnetic sources into a magnetizable material, the method comprising:
providing an inductor coil having multiple layers forming a coil and a hole extending through the multiple layers;
positioning the inductor coil next to the magnetizable material; and
emitting from the inductor coil a magnetic field that magnetizes an area on a surface of the magnetizable material, wherein the area on the surface of the magnetizable material is magnetized in a direction other than perpendicular to the magnetizable material such that there is a magnetic dipole with both a north polarity and a south polarity formed on the surface of the magnetizable material.

12. The method of claim 11, wherein the positioning step further includes a step of tilting the inductor coil with respect to the magnetizable material such that the inductor coil emits the magnetic field to magnetize the area of the surface of the magnetizable material in a direction other than perpendicular to the magnetizable material and other than parallel to the magnetizable material.

13. The method of claim 11, further comprising a step of placing a protective layer between the inductor coil and the magnetizable material.

14. The method of claim 11, wherein the multiple layers are welded to one another to form the coil with a number of turns.

15. The method of claim 14, wherein the weld is an overlap weld or a butt weld.

16. The method of claim 11, wherein a height of the coil which is a function of a thickness of each layer and the number of turns along with a width of the hole determines the area on the surface of the magnetizable material that is magnetized by the inductor coil.

17. The method of claim 11, wherein the inductor coil is placed in a casting compound.

18. The method of claim 11, wherein the hole formed in the inductor coil is a slanted hole.

19. The method of claim 11, wherein the hole formed in the inductor coil is either a rectangular-shaped hole, a circular-shaped hole, a triangular-shaped hole, or an oval-shaped hole.

20. The method of claim 11, further comprising steps of:
providing another inductor coil having multiple layers forming a coil and a hole extending through the multiple layers;
positioning the another inductor coil next to the magnetizable material; and
emitting from the another inductor coil a magnetic field that magnetizes another area on the surface of the magnetizable material, wherein the another area on the surface of the magnetizable material is magnetized in a perpendicular direction such that there is a magnetic dipole with either a north polarity or a south polarity formed on the surface of the magnetizable material.
